(19) United States
(12) Patent Application Publication
(10) Pub. No.: US 2015/0031353 A1
(43) Pub. Date: Jan. 29, 2015

(54) Apparatus, Method and Computer Program for Discovery Signalling

(71) Applicant: Broadcom Corporation, Irvine, CA (US)

(72) Inventors: Sami-Jukka Hakola, Kempele (FI); Samuli Turtinen, Ii (FI); Anna Pantelidou, Oulu (FI); Timo Koskela, Oulu (FI)

(21) Appl. No.: 14/374,564

(22) PCT Filed: Jan. 25, 2013
(86) PCT No.: PCT/IB2013/050654

§ 371 Date: Jul. 25, 2014

(30) Foreign Application Priority Data
Jan. 27, 2012 (GB) 1201374.4

(51) Int. Cl. H04W 48/16; H04W 8/00

(52) U.S. Cl. CPC H04W 48/16; H04W 8/005
USPC 455/422.1

(57) ABSTRACT

A first device receives a device-to-device D2D discovery signal which indicates that a second device which sent it does not have a cellular connection and/or is requesting relay to a network broader than a D2D network. In response, the first device engages in a search to find a cellular access node and reports its search results via D2D signalling. In non-limiting embodiments the indication can be explicit or may be implicit in the signal coding; the discovery signals of all devices are sent in periodic discovery signal intervals (204A-F) and any indication in a first discovery signal interval (204C) that a device needs a cellular connection triggers a common search by all the D2D devices in a second common search interval (208D) which is previous to the next discovery signal interval (204D) after the first (204C). The search results are reported in that next discovery signal interval (204D).

### TECHNICAL FIELD

The present invention relates to apparatus, a method and a computer program for discovery signalling. The exemplary and non-limiting embodiments of this invention relate generally to wireless communication systems, methods, devices and computer programs, and more specifically relate to discovery signalling in ad hoc device-to-device D2D communications.

### BACKGROUND

Abbreviations used in this description and/or in the referenced drawings are defined below following the Detailed Description section.

D2D communications have been the subject of increasing research in recent years. D2D encompasses direct communication among portable devices without utilising nodes/base stations of an infrastructure-based wireless network (typically a cellular network such as GSM, WCDMA, LTE or the like). There is a subset of D2D commonly termed M2M which refers to automated communications from and to portable radio devices that are not user controlled, such as for example smart meters, traffic monitors and the like. Typically M2M communications are infrequent and carry only small amounts of data as compared to cellular and D2D communications which are not M2M. To keep costs low, given their more focused purposes, many M2M devices have quite limited capabilities as compared to conventional UEs.

Specific to LTE and LTE-A systems there has been proposed a study item to evolve the LTE platform in order to intercept the demand of proximity-based applications by studying enhancements to the LTE radio layers that allow devices to discover each other directly over the air, and potentially communicate directly, when viable considering system management and network supervision. See for example documents Tdoc-RP-110706 entitled “On the need for a 3GPP study on LTE device-to-device discovery and communication”; Tdoc RP-110707 entitled “Study on LTE Device to Device Discovery and Communication—Radio Aspects”; and Tdoc-RP-110708 entitled “Study on LTE Device to Device Discovery and Communication—Service and System Aspects”; each by Qualcomm, Inc; TSG RAN#52; Bratislava, Slovakia; May 31-Jun. 3, 2011. Document RP-110106 describes one of the main targets is that the “radio-based discovery process needs also to be coupled with a system architecture and a security architecture that allow the 3GPP operators to retain control of the device behaviour, for example who can emit discovery signals, when and where, what information do they carry, and what devices should do once they discover each other.”

One 3GPP working group is currently discussing and defining use cases and service requirements for the D2D. Such use cases include social applications, local advertising, network offloading, smart meters and public safety. Specifically, social applications can use D2D for the exchange of files, photos, text messages, etc, VoIP conversations, one-way streaming video and two-way video conferencing. Multiplayer gaming can use D2D for exchanging high resolution media (voice & video) interactively either with all participants or only with team members within a game environment. In this gaming use case, the control inputs are expected to be received by all game participants with an ability to maintain causality. Network offloading can utilise D2D when an opportunistic proximity offload potential exists. For example, Device 1 can initiate transfer of a media flow from the macro network to a proximity communications session with Device 2, thereby conserving macro network resources while maintaining the quality of the user experience for the media session. Smart Meters can use D2D communication among low capability MTC devices, for vehicular communication (safety and non-safety purposes), and possibly also general M2M communication among different capability devices/machines. In the public safety regime, D2D can be made to have TETRA like functionality, and can be either network controlled D2D or a pure ad hoc D2D which does not utilise any network infrastructure for setting up or maintaining the D2D links. These are the two main categories of D2D networks, the former taking place under coverage of the controlling (cellular) network. These teachings are more relevant to the latter ad hoc D2D.

Consider the radio environment of FIG. 1. For a more compelling public safety example, assume there has been some disaster such as a tornado or hurricane which has damaged many cellular towers in a geographic area and so the cellular infrastructure network is not available. Communications in this scenario are critical but challenging. There are a group of five UEs 20-24 which together have formed an ad hoc D2D network via D2D links 26. This alone is limited and so there is a need to search for an available cellular access point to communicate with the outside world in order to get information out and to get the proper help and supplies in to the affected area. In the FIG. 1 example, assume that the only cellular access point available is the base station 30 whose coverage area extends only to the dashed line, so only UE 20 knows that this base station 30 is operational. UE 20 is shown as having a cellular link 28 but the scenario is similar if UE 20 is only in a radio resource control (RRC) idle state with the BS 30 rather than a full RRC connected state. In both cases, only UE 20 will be aware of the potential to establish a cellular pathway to communicate with the outside world.

This is in essence in accord with one example use case under consideration for 3GPP. As set forth at document S1-113009 entitled “Public Safety using LTE direct Communications” by Alcatel-Lucent, NIST, Nokia Siemens Networks and US Cellular; TSG SA1 Meeting #56; San Francisco, USA; 14-18 Nov. 2011, that use case is to:
Provide limited service in areas where there may not be radio coverage and/or if the radio coverage is lost due to a disaster and, when utilised, allowing a reliable form of communication between nearby end users. Proximity Service in absence of infrastructure needs to be available to specific classes of Public Safety users. For example, public safety personnel would be allowed to directly collaborate with one another when weather related events such as a tornado/typhoon hits and takes out a number of local towers.

In a normal LTE environment, when a UE is first powered up it does not have an IP address and its location is unknown. It starts a cell search and selection and system information acquisition. The cell search procedure consists of a series of synchronisation stages by which the UE determines the time and frequency parameters that are necessary to demodulate the downlink and to transmit uplink signals with the correct timing. US-A1-2011/01170907 discloses how one selects whether to use a direct cellular connection or a D2D relayed connection.

### SUMMARY

According to a first aspect of the present invention, there is provided a method for communicating, comprising: receiving at a first device a device-to-device D2D discovery signal which indicates that a second device which sent the discovery signal does not have a cellular connection and/or is requesting relay to a network broader than a D2D network; and in response, the first device engaging in a search to find a cellular access node and reporting a result of the search via D2D signalling.

According to a second aspect of the present invention, there is provided apparatus comprising: a processing system constructed and configured to cause the apparatus to perform at least: in response to receiving a device-to-device D2D discovery signal which indicates that a second device which sent the discovery signal does not have a cellular connection and/or is requesting relay to a network broader than a D2D network, engaging in a search to find a cellular access node and reporting a result of the search via D2D signalling.

The processing system may comprise at least one processor and at least one memory storing a computer program, the at least one memory with the computer program being configured with the at least one processor to cause the apparatus to perform as described above.

According to a third aspect of the present invention, there is provided a computer program comprising a set of instructions which, when executed on a first device, causes the first device to perform at least: in response to receiving at the first device a device-to-device D2D discovery signal which indicates that a second device which sent the discovery signal does not have a cellular connection and/or is requesting relay to a network broader than a D2D network, engaging in a search to find a cellular access node and reporting a result of the search via D2D signalling.

According to a fourth aspect of the present invention, there is provided apparatus comprising: means for, in response to receiving at a first device a device-to-device D2D discovery signal which indicates that a second device which sent the discovery signal does not have a cellular connection and/or is requesting relay to a network broader than a D2D network, engaging in a search to find a cellular access node and for reporting a result of the search via D2D signalling. In various of the exemplary embodiments below, the means for receiving may be a radio receiver and/or any of the circuits/circuitry referred to with reference to FIGS. 3 and/or 4; and the means for engaging in a search and for reporting the result may be also a radio receiver and a transmitter, and/or any of the circuits/circuitry referred to with reference to FIGS. 3 and/or 4.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows a schematic diagram illustrating an exemplary radio environment in which less than all devices/UEs in a D2D network have contact with a cellular base station, and is an exemplary environment in which these teachings may be used to advantage;

FIG. 2 shows a schematic diagram illustrating multiple D2D devices transmitting discovery signals and thereafter engaging in a common search for a cellular access node according to an exemplary embodiment of these teachings;

FIG. 3 shows a logic flow diagram that illustrates from the perspective of a D2D device the operation of a method, and a result of execution of computer program instructions embodied on a computer readable memory, in accordance with an exemplary embodiment of these teachings; and

FIG. 4 shows a simplified block diagram of two of the D2D devices and the eNB shown in FIG. 1, which are exemplary electronic devices suitable for use in practising the exemplary embodiments of this invention.

### DETAILED DESCRIPTION

Embodiments of these teachings form an ad hoc network using D2D discovery signals. To conserve power, it is convenient that all the participating D2D devices in a local area transmit their own discovery signals within a given time interval, termed herein a discovery signal transmission and reception interval. This allows any individual device to transmit its own discovery signal and to listen for such signals from other D2D devices, without having to be tuned continuously to the channel on which discovery signals are transmitted. Timing for when this interval is to occur may be based on a timing signal from an infrastructure/cellular network, or it may be self-organised by the D2D devices themselves according to a pre-arranged protocol. As one non-limiting example, the discovery signal first sent by any of the devices sets the timing for the D2D signalling and all other devices later joining in to add their own discovery signals know in advance to send it in the discovery signal transmission and reception interval defined by the original discovery signal that was first sent.

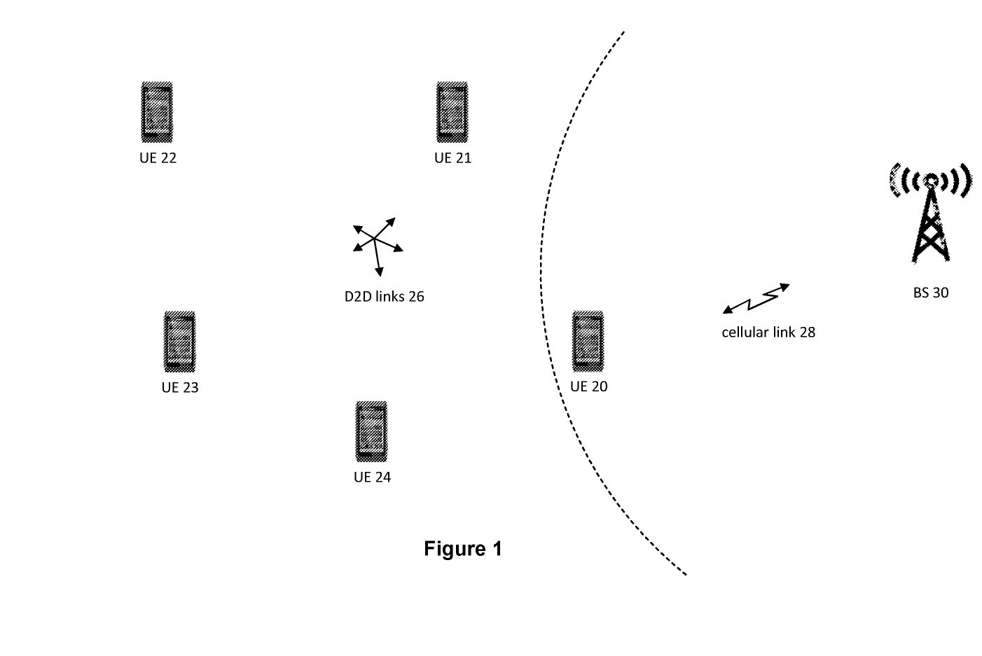

Considering the scenario set forth at FIG. 1, the D2D discovery signal includes a field that indicates whether or not the device sending that discovery signal has a cellular connection (or has detected a cell of a cellular network but is not connected to it). In an alternative embodiment, the D2D discovery message (all or part of it) can be coded in such a way to indicate to the receiving device that the device that sent the discovery signal has a cellular connection (or has detected a cell of a cellular network but is not connected to it). Such field or coding can also be used to indicate that the sending device is requesting a cellular connection, which means the sending device itself has not detected a cell but it does have data to send to over a cellular network if/when one were available.

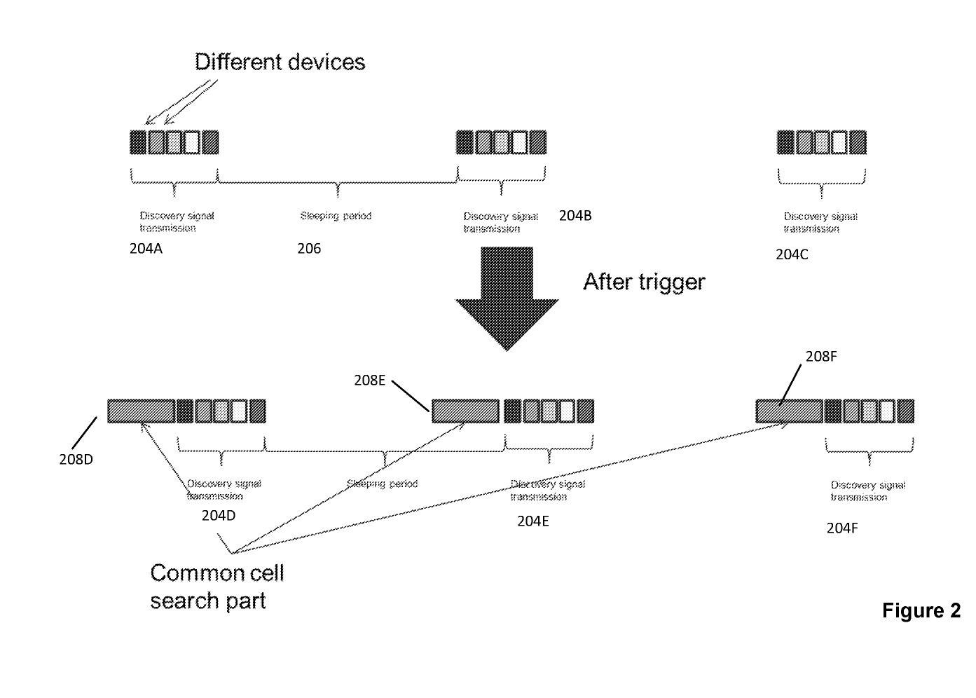

FIG. 2 illustrates an exemplary timing schedule for D2D discovery signals and cooperative cell searches according to one non-limiting implementation. There is a discovery signal transmission and reception interval 204A in which the various devices that wish to participate in D2D communications transmit their discovery signals and in which they listen for discovery signals from the other devices. This interval is periodic as shown at 204A through 204F and there is a sleeping period between them during which the devices that wish to exchange data may do so, and the devices that are not exchanging data can remain in a low power state. This periodical discovery process may be active in order that each device can keep up-to-date topology information in the ad hoc network.

In one non-limiting embodiment the co-operative cell search is based on demand for a cell search by one of the participating devices, which indicates the need for a cellular connection in its discovery signal that it sends in the discovery signal transmission and reception interval 204A. The indication that the sending device is requesting a cellular connection serves as an implicit trigger for all the listening devices to engage in a cooperative cell search in the next interval for common cell search 208D. In an example embodiment, the common cell search is triggered if, in the same interval 204A in which one device indicates a need for a cellular connection, there is no other device's discovery signal that indicates it has a cellular connection (or has detected a cellular cell).

Since the transmissions of discovery signals from the different D2D devices are in one example concentrated in the time domain to allow efficient energy saving possibilities, in one example of these teachings there is a common cell search period/interval 208D, 208E, 208F prior to the discovery signal transmission and reception intervals 204D, 204E, 204F. In this example, the results of each D2D device's search during that common interval 208D, 208E, 208F is reported in the subsequent discovery signal transmission and reception interval.

Consider the non-limiting example at FIG. 2. During discovery signal transmission and reception intervals 204A and 204B no discovery signal from any device requests a cell connection, meaning no common cell search has been triggered. During each of those, the five D2D devices shown at FIG. 1 send their discovery signal, and each listens to the other D2D devices' discovery signals also to see if there is a need for a cell search and also to see if there is a new (sixth) device sending its own discovery signal. During the discovery signal transmission and reception interval 204C, termed here the first interval for convenience, UE 22 of FIG. 1 indicates in its own discovery signal that it does not have a cellular connection (which also implies that it needs one) or that it is requesting relay to a cellular network. Assume for this example that no other UE of FIG. 1 knows whether a cell is near to it and so no other discovery signal by those other devices satisfies the request of UE 22.

Prior to the second interval 204D, all of those five devices 20-24 engage in a common cell search during interval 208D, which is immediately prior to the next subsequent (consecutive) discovery signal transmission and reception interval 204D. Referring to FIG. 1, assume UE 20 sees the BS 30 and reports that in the next consecutive discovery signal transmission and reception interval 204D. If the network of BS 30 is suitable for what UE 22 indicated it needs, the common cell search is terminated at the close of that discovery signal interval 204D assuming there are no further open requests. If there are, or if the BS 30 is not suitable for UE 22 (e.g. a different RAT than is compatible with UE 22), then the common search continues at the next consecutive interval for common cell search 208E, which precedes the discovery signal interval 204E and so forth with 208F and 204F as shown.

As one non-limiting example, the D2D device's report indicates the frequency band, RAT and PLMN ID for the case in which the cell search by the reporting D2D device 20 was successful. Or if the reporting D2D device's cell search was unsuccessful, its report includes in this example only the frequency band that it searched, in order to inform other D2D devices that this band has been searched and therefore removes redundant cell search on the same band by other devices 21-24, for example if the search needed to continue in a next common search interval.

The common cell search is in one example terminated when a suitable network has been found for the requesting device 22, and in the various D2D discovery signals there are no further active requests/indications for a cellular connection after some threshold (maximum) time period after a suitable network is reported. Or in case no D2D device reports a suitable network, the common cell search terminates after a certain time period automatically, since it may be that there are no suitable networks in the area to satisfy the current/active request. Assuming for the above non-limiting example of FIG. 2 that the common cell search is terminated after three common cell search intervals (204D, 204E and 204F in that example), then all D2D devices automatically terminate their cell searches at the close of search interval 208F, with no explicit signalling to indicate the search being done.

In another example embodiment, the D2D devices can search over different radio access technologies and frequencies. In one implementation of this general concept, statistics regarding the potential success in discovering a network are used to decide which RATs and/or frequency bands are to be searched, and so the order of the cell search depends on these statistics. In this way, the order of search can be from the highest (most) likely RAT and/or band to the lowest (least) likely technologies and/or frequencies to be available. This would reduce the number of searches in total, saving the limited UE power. Consider a specific example of such statistics-based search priorities. If there were a disaster in a region where an LTE base station is located, or where the density of LTE base stations is high, it is likely that the LTE network is down and so the statistical search priority would make other radio access technologies a higher priority than LTE networks.

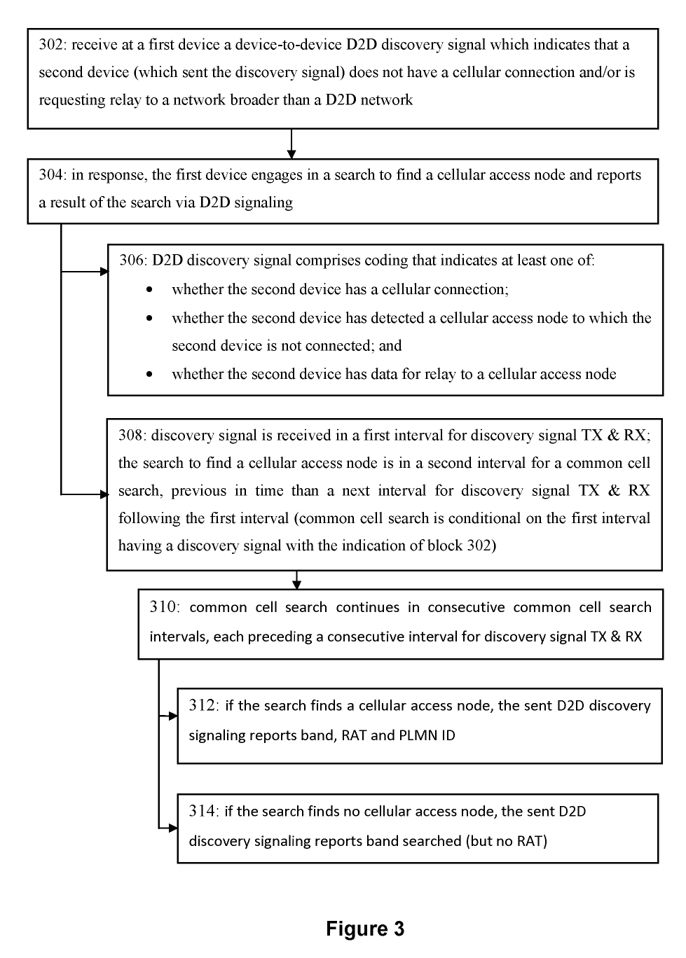

Now are detailed with reference to FIG. 3 further particular exemplary embodiments from the perspective of the portable communicating device. FIG. 3 may be performed by the whole first or second device 20, 22 shown at FIG. 1, or by one or several components thereof, such as a modem. The logic flow diagram of FIG. 3 may be considered to illustrate the operation of examples of a method, and a result of execution of a computer program stored in a computer readable memory, and a specific manner in which components of an electronic device are configured to cause that electronic device to operate. The various blocks shown in FIG. 3 may also be considered as a plurality of coupled logic circuit elements constructed to carry out the associated function(s), or specific result of strings of computer program code stored in a memory.

Such blocks and the functions they represent are non-limiting examples, and may be practised in various components such as integrated circuit chips and modules, and the exemplary embodiments of this invention may be realised in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Such circuit/circuitry embodiments include any of the following: (a) hardware-only circuit implementations (such as implementations in only analog and/or digital circuitry) and (b) combinations of circuits and software (and/or firmware), such as: (i) a combination of processor(s) or (ii) portions of processor(s)/software (including digital signal processor(s)), software, and memory(ies) that work together to cause an apparatus, such as a mobile phone/UE, to perform the various functions summarised at FIG. 3) and (c) circuits, such as a microprocessor(s) or a portion of a microprocessor(s), that require software or firmware for operation, even if the software or firmware is not physically present. This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” also covers, for example, a baseband integrated circuit or applications processor integrated circuit for a mobile phone/UE or a similar integrated circuit in a server, a cellular network device, or other network device which compiles the discovery signals as detailed by example above, and which directs the overall UE radio(s) to conduct the search in the common interval as detailed further above and according to these teachings.

At block 302 a first device 20 receives a device-to-device D2D discovery signal which indicates that a second device 22 which sent the discovery signal does not have a cellular connection and/or is requesting relay to a network broader than a D2D network. In response to this, at block 304 the first device engages in a search to find a cellular access node 30 and reports a result of the search via D2D signalling. For the case in which embodiments of these teachings are practised by one or more components for or circuitry for a UE, the receiving of block 302 need not be by a radio receiver but the signal can be received at an input to such implementing component(s)/circuitry from a radio receiver of a UE.

Further portions of FIG. 3 represent some of the specific but non-limiting embodiments detailed above. Block 306 summarises the above examples in which the D2D discovery signal comprises coding that indicates at least one of:
whether the second device has a cellular connection;
whether the second device has detected a cellular access node to which the second device is not connected; and
whether the second device has data for relay to a cellular access node.

Block 308 details the example above with respect to FIG. 2, namely that the discovery signal is received in a first interval 204C for discovery signal transmission and reception; the search to find a cellular access node is in a second interval 208D for a common cell search; and the second interval 208D is previous in time than a next interval for discovery signal transmission and reception 204D following the first interval 204C. As in that same example from above, the common cell search is conditional on at least one discovery signal within the first interval 204C indicating that a sending device 22 which sent the at least one discovery signal does not have a cellular connection and/or is requesting relay to a network broader than a D2D network.

Block 310 details further from that same example above, in that the common cell search continues in consecutive common cell search intervals 204D, 204E, 204F, each of which precedes a consecutive interval for discovery signal transmission and reception 204D, 204E, 204F. In the examples above, the common cell search continues until the earliest of: i) a predetermined time period has expired; and ii) at least one discovery signal in one of the intervals for discovery signal transmission and reception 204D, 204E, 204F indicates that a suitable cellular access node 30 has been found.

The remainder of FIG. 3 concerns the first device 20 reporting the results of its search, which in the above examples the first device 20 sends in its D2D discovery signalling. Block 312 indicates that if the search by the first device 20 finds a cellular access node 30, the D2D discovery signalling sent from the first device 20 comprises indications of: i) frequency band on which the cellular access node was found, and ii) a radio access technology on which the cellular access node 30 operates, and iii) at least one of an identifier of the cellular access node 30 found in the search and an identifier of a public land mobile network PLMN of which the cellular access node 30 is a part. Block 314 summarises the above example of the first device's reporting if its search finds no cellular access node: its D2D discovery signalling comprises an identifier of all frequency bands searched (but not any identifier of any radio access technology).

As noted above, in an example, the search by the first device 20 to find a cellular access node 30 is according to a search priority derived from statistics describing relative likelihood of success in finding a cellular access node 30, at least one category of the search priority being radio access technology or frequency.

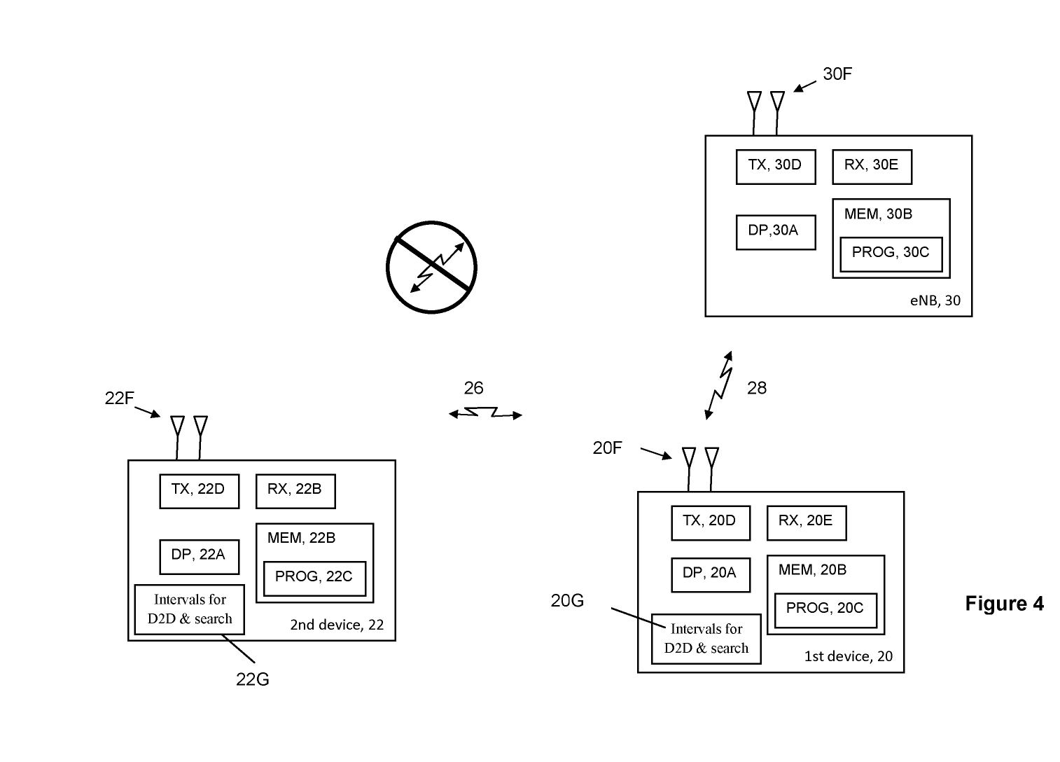

Reference is now made to FIG. 4 for illustrating a simplified block diagram of various electronic devices and apparatus that are suitable for use in practising the exemplary embodiments of this invention. In FIG. 4, there is a first device 20 operating which is proximate to an eNB 30 and is in wireless contact with it via wireless link 28, and there is also a second device 22 which has no direct wireless contact with the eNB 30 but which is in communication with the first device 20 via wireless link 26. Not shown are higher network nodes for the LTE/E-UTRAN system which provide connectivity with further networks such as for example a publicly switched telephone network PSTN and/or a data communications network/Internet. There may also be a data and/or control path (not shown) coupling the eNB 30 with other eNBs (not shown).

The first device 20 includes processing means such as at least one data processor (DP) 20A, storing means such as at least one computer-readable memory (MEM) 20B storing at least one computer program (PROG) 20C, communicating means such as a transmitter TX 20D and a receiver RX 20E for bidirectional wireless communications with the eNB 30 and with the second device 22 via one or more antennas 20F. While only one transmitter and receiver are shown, it is understood there may be more than one. Inherent in the first device (for example in the DP 20A) is also a clock from which various software-defined timers are run, such as for example to align transmissions and receptions with the various intervals 204A, 208D mentioned above. Also stored in the MEM 20B at reference number 20G is the rules or algorithm for transmitting and receiving in those intervals as detailed above for the various embodiments. The second device 22 is functionally similar with blocks 22A, 22B, 22C, 22D, 22E, 22F and 22G. The first and second devices 20, 22 communicate with one another directly according to the various described embodiments using the direct wireless link 26.

The eNB 30, or more generally the network access node, also includes processing means such as at least one data processor (DP) 30A, storing means such as at least one computer-readable memory (MEM) 30B storing at least one computer program (PROG) 30C, and communicating means such as a transmitter TX 30D and a receiver RX 30E for bidirectional wireless communications with the UE 20 via one or more antennas 30F.

While not particularly illustrated for the devices 20, 22 or the network access nodes 30, those apparatus are also assumed to include as part of their wireless communicating means a modem which may be inbuilt on an RF front end chip within those devices 20, 22, 30 and which also carries the TX 20D/22D/30D and the RX 20E/22E/30E.

At least one of the PROGs 20C/22C in the first and second devices 20, 22 is assumed to include program instructions that, when executed by the associated DP 20A/22A, enable the device to operate in accordance with the exemplary embodiments of this invention, as was discussed above in detail. In this regard, the exemplary embodiments of this invention may be implemented at least in part by computer software stored on the MEM 20B, 22B which is executable by the DP 20A/22A of the communicating devices 20, 22; or by hardware, or by a combination of tangibly stored software and hardware (and tangibly stored firmware). Electronic devices implementing these aspects of the invention need not be the entire apparatus 20, 22 as shown, but exemplary embodiments may be implemented by one or more components of same such as the above described tangibly stored software, hardware, firmware and DP, or a system-on-a-chip SOC or an application specific integrated circuit ASIC or a digital signal processor DSP.

In general, the various embodiments of the first and/or second device 20, 22 can include, but are not limited to: data cards, USB dongles, user equipments, cellular telephones; personal portable digital devices having wireless communication capabilities including but not limited to laptop/palmtop/tablet computers, digital cameras and music devices, Internet appliances, remotely operated robotic devices or machine-to-machine communication devices.

Various embodiments of the computer readable MEMs 20B/22B/30B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 20A/22A/30A include but are not limited to general purpose computers, special purpose computers, microprocessors, digital signal processors (DSPs) and multi-core processors.

Various modifications and adaptations to the foregoing exemplary embodiments of this invention may become apparent to those skilled in the relevant arts in view of the foregoing description. While the exemplary embodiments have been described above in the context of a nearby access node of a E-UTRAN (LTE/LTE-A) system, it should be appreciated that the exemplary embodiments of this invention are not limited for use with only this one particular type of wireless communication system, and that they may be used to advantage in other wireless communication systems/RATs, such as for example GERAN, UTRAN and others.

Some of the various features of the above non-limiting embodiments may be used to advantage without the corresponding use of other described features. The foregoing description should therefore be considered as merely illustrative of the principles, teachings and exemplary embodiments of this invention, and not in limitation thereof.

The following abbreviations used in the above description and/or in the drawing figures are defined as follows:

3GPP Third Generation Partnership Project

BS base station

D2D device to device

eNB evolved NodeB (BS of a LTE/LTE-A system)

E-UTRAN evolved UTRAN

IP Internet Protocol

LTE Long Term Evolution (evolved UTRAN)

LTE-A Long Term Evolution Advanced

M2M machine to machine

MTC machine type communication

RAT radio access technology

RF radio frequency

UE user equipment

UTRAN Universal Terrestrial Radio Access Network

VoIP voice over Internet Protocol

1. A method for communicating, comprising:
receiving at a first device a device-to-device (D2D) discovery signal which indicates that a second device which sent the discovery signal does not have a cellular connection and/or is requesting relay to a network broader than a D2D network; and in response,
the first device engaging in a search to find a cellular access node and reporting a result of the search via D2D signalling.

2. A method according to claim 1, in which the D2D discovery signal comprises coding that indicates at least one of:
whether the second device has a cellular connection;
whether the second device has detected a cellular access node to which the second device is not connected; and
whether the second device has data for relay to a cellular access node.

3. A method according to claim 1, in which:
the discovery signal is received in a first interval for discovery signal transmission and reception;
the search to find the cellular access node is in a second interval for a common cell search; and
the second interval is previous in time than a next interval for discovery signal transmission and reception following the first interval.

4. A method according to claim 3, in which the common cell search is conditional on at least one discovery signal within the first interval indicating that a sending device which sent the at least one discovery signal does not have a cellular connection and/or is requesting relay to a network broader than a D2D network.

5. A method according to claim 4, in which the common cell search continues as necessary in consecutive common cell search intervals each of which precedes a consecutive interval for discovery signal transmission and reception, and the common cell search continues until the earliest of:
a predetermined time period has expired; and
at least one discovery signal in one of the intervals for discovery signal transmission and reception indicates that a suitable cellular access node has been found.

6. A method according to claim 1, in which reporting the result of the search is in D2D discovery signalling sent from the first device.

7. A method according to claim 6, wherein if the search by the first device finds a cellular access node, the D2D discovery signalling sent from the first device comprises indications of:
frequency band on which the cellular access node was found, and
a radio access technology on which the cellular access node operates, and
at least one of an identifier of the cellular access node found in the search and an identifier of a public land mobile network (PLMN) of which the cellular access node is a part.

8. A method according to claim 6, wherein if the search by the first device finds no cellular access node, the D2D discovery signalling sent from the first device comprises an identifier of all frequency bands searched, but not any identifier of any radio access technology.

9. A method according to claim 1, in which the search by the first device to find the cellular access node is according to a search priority derived from statistics describing relative likelihood of success in finding a cellular access node, at least one category of the search priority being radio access technology or frequency.

10. An apparatus for communicating, the apparatus comprising:
a processing system comprising at least one data processor and at least one computer-readable memory storing at least one computer program, wherein the processing system is constructed and configured to cause the apparatus to perform at least:
in response to receiving a device-to-device (D2D) discovery signal which indicates that a second device which sent the discovery signal does not have a cellular connection and/or is requesting relay to a network broader than a D2D network, engaging in a search to find a cellular access node and reporting a result of the search via D2D signalling.

11. The apparatus according to claim 10, in which the D2D discovery signal comprises coding that indicates at least one of:
whether the second device has a cellular connection;
whether the second device has detected a cellular access node to which the second device is not connected; and
whether the second device has data for relay to a cellular access node.

12. The apparatus according to claim 10, in which:
the discovery signal is received in a first interval for discovery signal transmission and reception;
the search to find a cellular access node is in a second interval for a common cell search; and
the second interval is previous in time than a next interval for discovery signal transmission and reception following the first interval.

13. The apparatus according to claim 12, in which the common cell search is conditional on at least one discovery signal within the first interval indicating that a sending device which sent the at least one discovery signal does not have a cellular connection and/or is requesting relay to a network broader than a D2D network.

14. The apparatus according to claim 13, in which the common cell search continues as necessary in consecutive common cell search intervals each of which precedes a consecutive interval for discovery signal transmission and reception, and the common cell search continues until the earliest of:
a predetermined time period has expired; and
at least one discovery signal in one of the intervals for discovery signal transmission and reception indicates that a suitable cellular access node has been found.

15. The apparatus according to claim 10, in which reporting the result of the search is in D2D discovery signalling sent from the apparatus.

16. The apparatus according to claim 15, wherein if the search by the apparatus finds a cellular access node, the D2D discovery signalling sent from the apparatus comprises indications of:
frequency band on which the cellular access node was found, and
a radio access technology on which the cellular access node operates, and
at least one of an identifier of the cellular access node found in the search and an identifier of a public land mobile network (PLMN) of which the cellular access node is a part.

17. The apparatus according to claim 15, wherein if the search by the apparatus finds no cellular access node, the D2D discovery signalling sent from the apparatus comprises an identifier of all frequency bands searched, but not any identifier of any radio access technology.

18. The apparatus according to claim 10, in which the search by the apparatus to find a cellular access node is according to a search priority derived from statistics describing relative likelihood of success in finding a cellular access node, at least one category of the search priority being radio access technology or frequency.

19. A computer readable memory storing a set of instructions which, when executed on a first device, causes the first device to perform at least:
in response to receiving at the first device a device-to-device (D2D) discovery signal which indicates that a second device which sent the discovery signal does not have a cellular connection and/or is requesting relay to a network broader than a D2D network, engaging in a search to find a cellular access node and reporting a result of the search via D2D signalling.

20. The computer readable memory according to claim 19, in which the D2D discovery signal comprises coding that indicates at least one of:
whether the second device has a cellular connection;
whether the second device has detected a cellular access node to which the second device is not connected; and
whether the second device has data for relay to a cellular access node.

21-30. (canceled)
